(19) United States
(12) Patent Application Publication
(10) Pub. No.: US 2014/0120921 A1
(43) Pub. Date: May 1, 2014

(54) METHODS, APPARATUSES AND COMPUTER PROGRAM PRODUCTS FOR PROVIDING AN OPTIMIZED HANDOVER PREPARATION AND EXECUTION OPERATION

(71) Applicants: IIkka Antero Keskitalo, Oulu (FI); Jarkko Tuomo Koskela, Oulu (FI); Jussi-Pekka Koskinen, Oulu (FI); Lars Dalsgaard, Oulu (FI)

(72) Inventors: IIkka Antero Keskitalo, Oulu (FI); Jarkko Tuomo Koskela, Oulu (FI); Jussi-Pekka Koskinen, Oulu (FI); Lars Dalsgaard, Oulu (FI)

(73) Assignee: NOKIA CORPORATION, Espoo (FI)

(21) Appl. No.: 14/127,449

(22) PCT Filed: Jun. 21, 2011
(86) PCT No.: PCT/IB2011/001408

§ 371 Date: Dec. 18, 2013

(51) Int. Cl. H04W 36/00

(52) U.S. Cl. CPC H04W 36/0016
USPC 455/438; 455/561

(57) ABSTRACT

An apparatus for minimizing the recovery time of connecting to a network may include a processor and memory storing executable computer code causing the apparatus to at least perform operations including receiving a message including a preparatory handover command indicating one or more candidate target cells for handover and data indicating that the candidate target cells are selectable for handover in response to a future detection of one or more handover conditions. The computer program code may further cause the apparatus to initiate a selection of one of the candidate target cells for handover of an apparatus in response to detection of at least one of the handover conditions. The computer program code may further cause the apparatus to enable handover of the apparatus to the selected candidate target cell. Corresponding methods and computer program products are also provided.

### TECHNOLOGICAL FIELD

An example embodiment of the present invention relates generally to wireless communication technology and more particularly, relates to an apparatus, method and a computer program product for providing an efficient and reliable mechanism of minimizing a recovery time for connecting to a communications network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. For instance, the evolved universal mobile telecommunications system (UMTS) terrestrial radio access network (E-UTRAN) is currently being developed. The E-UTRAN, which is also known as Long Term Evolution (LTE) or 3.9G, is aimed at upgrading prior technologies by improving efficiency, lowering costs, improving services, making use of new spectrum opportunities, and providing better integration with other open standards.

An advantage of E-UTRAN which continues to be shared with other preceding telecommunication standards is the fact that users are enabled to access a network employing such standards while remaining mobile. Thus, for example, users having mobile terminals equipped to communicate in accordance with such standards may travel vast distances while maintaining communication with the network. By providing access to users while enabling user mobility, services may be provided to users while the users remain mobile. However, the mobility of users typically requires the network to provide continuity of service to the mobile users by enabling a user's mobile terminal to be handed over between different serving stations within corresponding different cells or service areas. In this regard, in order to maximize the user's experience the impact of degraded radio conditions in the network should typically be limited. Nevertheless, despite radio network planning and coverage verification, there may be situations in which a mobile terminal experiences poor connection quality leading either to worse data throughput or connection failures. Such situations are typically more common at the edges of cells where the mobile terminal is typically supposed to measure and identify candidate cells for possible handover. Some examples of poor radio quality, which may affect a connection, may be caused by fast or slow fading (e.g., shadowing), excessive interference (e.g., either in uplink or downlink), incorrectly set mobility parameters, etc.

Before the mobile terminal loses a connection to a serving cell, a configured mobility event may typically trigger a measurement reporting in order to initiate a handover to a new (e.g., best neighbor) cell. The network then typically sends a handover command including the information about the target cell where to move the connection.

If the mobility, e.g., handover to a new cell, is not triggered early enough, or, if the mobile terminal moves to an area of poor radio network coverage, the connection may be broken. In such a situation, the mobile terminal may attempt first to restore to connection using a call re-establishment procedure. At present, if the mobile terminal is unable to restore the connection by a call re-establishment procedure, the mobile terminal typically enters an idle mode and starts a cell selection procedure in order to find a suitable cell for connection. Currently, the connection re-establishment may fail not only due to radio circumstances but also in an instance in which the mobile terminal context is not available in the selected cell. This may be a typical situation in instances in which a handover procedure may encounter problems in early stages.

The connection may be lost not only during the mobility situations but also due to poor network coverage in certain areas of the network. In addition, the interference caused by the same layer cells (e.g., intra frequency) may typically cause connection problems. In some instances, the mobility measurements may not have triggered and the mobile terminal may begin to identify problems in a layer 1 (L1) connection. In an instance in which a connection with a network is lost, a mobile terminal may try first to re-establish the connection. If the attempt to reestablish the connection fails, the mobile terminal typically enters an idle mode and may start a cell selection procedure.

When the failure happens there is typically a delay in how soon the mobile terminal is able to restore the connection to the network. In this regard, the cell selection may take a relatively long time which may cause degradation in the data throughput and mobility behavior. In many scenarios, this delay may lead to drawbacks related to undesirable user experiences, dropped voice calls, etc. which may be burdensome for the user.

In view of the foregoing problems, it may be beneficial to provide a mechanism in which to reduce the impact of failed radio connections and/or poor radio quality by minimizing the recovery time for connecting to a network in a reliable and efficient manner.

### BRIEF SUMMARY

A method, apparatus and computer program product are therefore provided that may minimize the recovery time of establishing a connection to a network. An example embodiment of the invention may facilitate generation of a message with handover related information (e.g., a preparatory handover command) prior to detection of a network connection failure(s) or a deterioration in radio quality. This may be achieved by sending a handover command (e.g., a preparatory handover command) to a user terminal (e.g., User Equipment (UE)) prior to detection of a network connection failure(s) or deterioration in radio quality or conditions to enable a fast reconnection with the network.

The preparatory handover command may include data indicating one or more candidate cells which have the highest probability of enabling the user terminal to restore the connection to the network. The candidate cells may be informed in advance of a handover for example, that the user terminal may be handed over to the candidate cells in response to detection of a future network connection failure(s) and/or detection of deterioration in radio quality or conditions.

In an instance in which the user terminal may experience a radio link failure or otherwise loses a connection with a network and a recovery procedure fails upon expiration of a predetermined time period, the user terminal may select one of the candidate cells, identified in a message including the preparatory handover command, as a target cell for handover. In response to selecting the target cell, the user terminal may be handed over to the target cell and may send a handover complete message to the target cell indicating that the handover is complete. The selection of the target cell by the user terminal may be based on one or more measurement results available at the time of a detected network connection failure or deterioration in radio quality or conditions based on measurements (e.g., received symbol reference power (RSRP) levels/values, received symbol reference quality (RSRQ) levels/values, etc.) of candidate cells identified in the message including the preparatory handover command.

In one example embodiment, a method for minimizing the recovery time of connecting to a network is provided. The method may include receiving a message indicating a preparatory handover command indicating one or more candidate target cells for handover and data indicating that the candidate target cells are selectable for handover in response to a future detection of one or more handover conditions. The method may further include initiating a selection of one of the candidate target cells for handover of an apparatus in response to detection of at least one of the handover conditions. The method may further include enabling handover of the apparatus to the selected candidate target cell.

In another example embodiment, an apparatus for minimizing the recovery time of connecting to a network is provided. The apparatus may include a processor and memory including computer program code. The memory and the computer program code are configured to, with the processor, cause the apparatus to at least perform operations including receiving a message indicating a preparatory handover command indicating one or more candidate target cells for handover and data indicating that the candidate target cells are selectable for handover in response to a future detection of one or more handover conditions. The computer program code may further cause the apparatus to initiate a selection of one of the candidate target cells for handover of the apparatus in response to detection of at least one of the handover conditions. The computer program code may further cause the apparatus to enable handover of the apparatus to the selected candidate target cell.

In another example embodiment, a computer program product for minimizing the recovery time of connecting to a network is provided. The computer program product includes at least one computer-readable storage medium having computer-executable program code portions stored therein. The computer-executable program code instructions may include program code instructions configured to facilitate receipt of a message indicating a preparatory handover command indicating one or more candidate target cells for handover and data indicating that the candidate target cells are selectable for handover in response to a future detection of one or more handover conditions. The program code instructions may also be configured to initiate a selection of one of the candidate target cells for handover of an apparatus in response to detection of at least one of the handover conditions. The program code instructions may also be configured to enable handover of the apparatus to the selected candidate target cell.

In another example embodiment, a method for minimizing the recovery time of connecting to a network is provided. The method may include generating a message including a preparatory handover command indicating one or more candidate target cells for handover. The preparatory handover command may also include data indicating that the candidate target cells are selectable for handover in response to a future detection of one or more handover conditions. The method may further include facilitating sending of the message to an apparatus to enable handover of the apparatus to a selected target cell of the candidate target cells in response to detection of at least one of the handover conditions.

In another example embodiment, an apparatus for minimizing the recovery time of connecting to a network is provided. The apparatus may include a processor and memory including computer program code. The memory and the computer program code are configured to, with the processor, cause the apparatus to at least perform operations including generating a message including a preparatory handover command indicating one or more candidate target cells for handover. The preparatory handover command may also include data indicating that the candidate target cells are selectable for handover in response to a future detection of one or more handover conditions. The computer program code may further cause the apparatus to facilitate sending of the message to a device to enable handover of the device to a selected target cell of the candidate target cells in response to detection of at least one of the handover conditions.

An example embodiment of the invention may therefore provide an efficient, reliable and fast manner for a user terminal to establish a connection to a network in response to detection of a network connection failure and/or deteriorations in radio quality to enable improved capabilities with respect to telecommunications services.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a wireless communications system according to an example embodiment of the invention;

FIG. 2 is a schematic block diagram of a system for minimizing a recovery time of establishing a connection with a network according to an example embodiment of the invention;

FIG. 3 is a schematic block diagram of an apparatus for minimizing a recovery time of establishing a connection with a network according to an example embodiment of the invention;

FIG. 4 is a schematic block diagram of an apparatus embodied at a network device for minimizing a recovery time of establishing a connection with a network according to an example embodiment of the invention;

FIG. 5 is a diagram of a message including a preparatory handover command according to example embodiment of the invention;

FIG. 6 is a control flow diagram illustrating a mechanism for minimizing a recovery time of establishing a connection with a network according to an example embodiment of the invention;

FIG. 7 is a flowchart according to an example method for minimizing a recovery time of establishing a connection with a network according to an example embodiment of the invention; and

FIG. 8 is another flowchart according to an example method for minimizing a recovery time of establishing a connection with a network according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As referred to herein, radio link failure may, but need not, be a condition in which a radio communication path(s), channel(s), system(s) or the like is unable to transfer or successfully perform data transmission or communication processes within desired parameters (e.g., excessive transmission delay, excessive error conditions, loss of connectivity with a network, etc). The radio link failure may, but need not, be detected by a communication device based on the expiration of a transmission timer(s), by counting one or more packets or any other suitable manner.

As referred to herein, handover, may but need not, denote a UE (e.g., mobile terminal, mobile phone, etc.) initiated cell change for example based on the received information in a preparatory handover message (e.g., a preparatory handover command), or a UE initiated handover based on the received information. Additionally, as referred to herein, the term(s) candidate target cell(s) and similar terms may be used interchangeably to refer to a potential candidate target cell(s).

An example embodiment of the invention may relate to minimizing the recovery time for establishing or reestablishing a lost connection to a network. In this regard, an example embodiment may minimize a recovery time of establishing or reestablishing a connection to a network in instances in which one or more devices (e.g., User Equipment (UE), an eNB, etc.) may detect a poor radio quality/conditions, one or more radio connection issues (e.g., one or more failures (e.g., RLF)) and/or one or more failures that may, but need not, be associated with a handover procedure including, but not limited to: (1) a UE losing a connection before a configured event (e.g., generation of a measurement report(s)) triggers; (2) a UE being unable to send a measurement report to the network due to a lost connection; (3) an eNB being unable to receive/decode a measurement report; (4) a handover (HO) command being unsuccessfully received by a UE; and (5) a UE being unable to establish a connection on a target cell, or any other conditions that may impact the connection of a UE with a network.

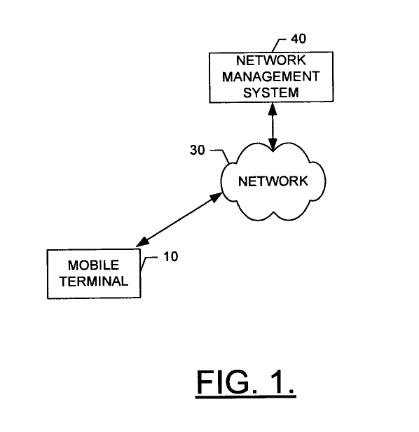

FIG. 1 illustrates a generic system diagram in which a device such as a mobile terminal 10, which may benefit from embodiments of the present invention, is shown in an example communication environment. As shown in FIG. 1, a system in accordance with an example embodiment of the present invention includes a communication device (e.g., mobile terminal 10) that may be capable of communication with a network 30. The mobile terminal 10 may be an example of one of several communications devices of the system that may be able to communicate with network devices or with each other via the network 30. In some cases, various aspects of operation of the network 30 may be managed by one or more network devices. As an example, the network 30 may include a network management system 40, which may be involved with (perhaps among other things) performing network management functions.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of voice and text communications systems, can readily employ embodiments of the present invention.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like.

One or more communication terminals such as the mobile terminal 10 and other communication devices may be capable of communication with each other via the network 30 and each may include an antenna or antennas for transmitting signals to and for receiving signals from a base site, which could be, for example a base station (e.g., an E-UTRAN node B (eNB)) that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the other communication devices via the network 30. By directly or indirectly connecting the mobile terminal 10 and the other communication devices to the network 30, the mobile terminal 10 and the other communication devices may be enabled to communicate with network devices and/or each other, for example, according to numerous communication protocols including Hypertext Transfer Protocol (HTTP) and/or the like, to thereby carry out various communication or other functions of the mobile terminal 10 and the other communication devices, respectively.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 30 and other devices by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the network management system 40 may be a device, node or collection of devices and nodes such as a server, computer or other network device. The network management system 40 may have any number of functions or associations with various services. As such, for example, the network management system 40 may be a platform such as a dedicated server (or server bank) associated with a particular information source or service (e.g., network management services), or the network management system 40 may be a backend server associated with one or more other functions or services. As such, the network management system 40 represents a potential host for a plurality of different network management services. In some embodiments, the functionality of the network management system 40 is provided by hardware and/or software components configured to operate in accordance with known techniques for the provision of network management services to the network 30. However, at least some of the functionality provided by the network management system 40 may be provided in accordance with example embodiments of the invention.

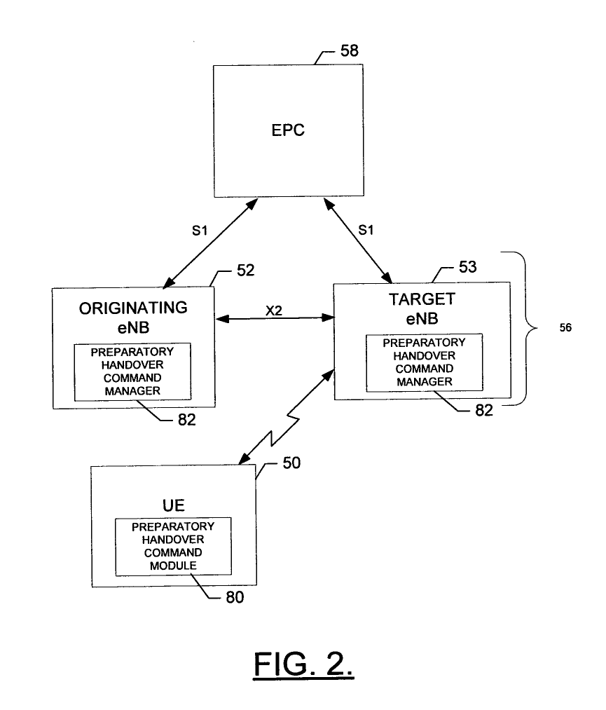

An example embodiment of the invention will now be described with reference to FIG. 2, in which certain elements of a system for minimizing a recovery time for establishing a connection with a network are displayed. The system of FIG. 2 represents a specific example embodiment of a network such as the general network displayed in FIG. 1, except that FIG. 2 represents a general block diagram of an E-UTRAN. As such, in connection with FIG. 2, user equipment (UE) 50 may be an example of one embodiment of the mobile terminal 10 of FIG. 1 and E-UTRAN node Bs (eNBs) 52 and 53 may be examples of base stations or access points that may serve respective cells or areas within the network 30 to, together with other eNBs, define the coverage provided by the network 30 to mobile users. However, it should be noted that the system of FIG. 2, may also be employed in connection with a variety of other devices, both mobile and fixed, and therefore, embodiments of the present invention should not be limited to application on devices such as the mobile terminal 10 of FIG. 1 or the network devices of FIG. 2. Moreover FIG. 2, which illustrates E-UTRAN components, should be understood to be just an example of one type of network with which embodiments of the present invention may be employed. However, other example embodiments may be practiced in similar fashion with respect to UTRAN or even other networks.

Referring now to FIG. 2, the system includes an E-UTRAN 56 which may include, among other things, a plurality of node-Bs in communication with an evolved packet core (EPC) 58 which may include one or more mobility management entities (MMEs) (not shown) and one or more system architecture evolution (SAE) gateways (not shown). The node-Bs may be E-UTRAN node-Bs (e.g., eNBs such as originating eNB 52 and target eNB 53) and may also be in communication with the UE 50 and other UEs. The E-UTRAN 56 may be in communication with the EPC 58. In an example embodiment, the network management system 40 of FIG. 1 may be an example of a device or collection of devices within the EPC 58 that may be configured to employ an example embodiment of the present invention. Each of the eNBs 52 and 53 may communicate with each other via an eNB to eNB interface such as, for example, an X2 interface. As referred to herein, an X2 interface may be a physical and/or logical interface between eNBs to facilitate communications between the eNBs. Additionally or alternatively, each of the eNBs 52 and 53 may communicate with each other via an S1 interface in which each eNB may send a message to the EPC 58. The EPC (also referred to herein as core network) may send the message to a corresponding eNB via an S1 interface. The S1 interface may be a physical and/or logical interface between eNBs and the EPC. In this regard, the eNBs and the EPC may communicate via the S1 interface. In an example embodiment, the eNBs 52 and 53 may exchange data such as, for example, one or more handover requests and one or more handover request acknowledgements between each other via an X2 interface.

The handover request may include data that may indicate that a corresponding handover command associated with the handover request may not be a normal handover command that may require an instant reaction by the UE 50 to attempt to establish a connection to a target cell (e.g., target eNB 53) by sending a handover complete message to the target cell. Rather, the handover request may include data specifying that the handover request relates, in part, to a preparatory handover command to be utilized in the event of a future connection failure (e.g., a connection failure with a network) or deterioration in radio quality/conditions, etc., as described more fully below. In this regard, the handover request may include data indicating that an extended handover command sent by a source cell (e.g., originating eNB 52) to the UE 50 is a preparatory handover command and the target cell (e.g., target eNB 53) may respond by sending a message (e.g., a modified handover request acknowledgement (ack) message) to the source cell (e.g., originating eNB 52) including appropriate parameters that may be utilized for generating a complete handover command by the source cell. The parameters may include, but are not limited to, RadioResourceConfigCommon parameters, RACH-ConfigDedicated parameters and any other suitable parameters. Upon receipt, the parameters may be stored in a memory of the source cell. As such, the parameters may not need to be sent from the target cell to the source cell in an instance in which the target cell previously sent the parameters to the source cell. For example, in this regard, the target cell may only send the parameters to the source cell in instances in which the parameters may have changed since the parameters were previously sent to the source cell. It should be pointed out that the eNBs 52 and 53 may exchange one or more handover requests and one or more handover request acknowledgements between each other via the S1 interface in a manner analogous to that described above without departing from the spirit and scope of the invention.

In some example embodiments, instances of a preparatory handover command manager 82 may be present at each of the eNBs 52 and 53 to control continuity of handover in response to detection of one more connection failures (e.g., a network connection failure(s)), one or more deteriorations in radio quality (e.g., deterioration in radio link quality), etc., as described in greater detail below. However, it should be appreciated that in some embodiments, rather than employing instances of the preparatory handover command manager 82 at each respective eNB, the EPC 58 may employ an instance of the preparatory handover command manager 82 and may direct operations of the eNBs accordingly.

The eNBs 52 and 53 may provide E-UTRA user plane and control plane (radio resource control (RRC)) protocol terminations for the UE 50. The eNBs 52 and 53 may provide functionality hosting for such functions as radio resource management, radio bearer control, radio admission control, connection mobility control, dynamic allocation of resources to UEs in both uplink and downlink, selection of an MME at UE attachment, IP header compression and encryption, scheduling of paging and broadcast information, routing of data, measurement and measurement reporting for configuration mobility, and the like.

The MME may host functions such as distribution of messages to respective node-Bs, security control, idle state mobility control, EPS (Evolved Packet System) bearer control, ciphering and integrity protection of (non access stratum) NAS signaling, and the like. The SAE gateway may host functions such as termination and switching of certain packets for paging and support of UE mobility. In an example embodiment, the EPC 58 may provide connection to a network such as the Internet. As shown in FIG. 2, the eNBs 52 and 53 may each include a preparatory handover command manager 82 configured to execute functions associated with each corresponding eNB with respect to receiving information from and/or providing information to the UE 50, the EPC 58 and/or other eNBs related to, for example, communication format parameters and/or measurement parameters for handover, measurement reports, as well as generation of one or expanded handover commands (e.g., preparatory handover commands), one or more modified handover request acknowledgements and any other suitable data, as described more fully below.

In an example embodiment of the system of FIG. 2, the preparatory handover command module 80 of UE 50 may generate one or more measurement reports that may include data indicating measurements obtained from a source/serving cell (e.g., originating eNB 52) as well as data indicating measurements obtained from one or more neighboring cells (e.g., target eNB 53). The measurements may include, but are not limited to, reference signal received power (RSRP) from the source/serving cell and one or more neighboring cells, which may indicate a power level(s)/value(s) (for example, in decibels (dB)) of the corresponding cell. Additionally, the measurements of the measurement reports may include, but are not limited to, reference symbol received quality (RSRQ) levels measured on the source/serving cell (e.g., originating eNB 52) and one or more neighboring cells (e.g., target eNB). The RSRQ levels may indicate a level of quality associated with a corresponding cell (e.g., originating eNB 52, target eNB 53, etc.), and any other suitable data.

The preparatory handover command module 80 of the UE 50 may provide the measurement reports to a source/serving cell (e.g., originating eNB 52). The preparatory handover command manager 82 of the source/serving cell (e.g., originating eNB 52) may utilize the data of the measurement reports received from the UE 50, data obtained from one or more measurement reports generated by the source/serving cell, data associated with a layout of a network or any other suitable data to generate an expanded handover command (e.g., a command or message including a preparatory handover command). For instance, the preparatory handover command manager 82 of the source/serving cell may utilize this information to determine which neighboring cell(s) may be a viable candidate(s) cell (e.g., target eNB 53) for handover of the UE 50 in the event of a detection of a future network connection failure(s) (e.g., RFL), deterioration in radio conditions (e.g., radio quality), etc. In one example embodiment, the preparatory handover command manager 82 of the source/serving cell (e.g., originating eNB 52) may determine that one or more of the corresponding neighboring cells are viable candidate cells for handover of the UE 50, in response to detecting that one or more of the neighboring cells has a RSRP level/value with a predetermined power (e.g., 1 dB higher, 2 dB higher, 3 dB higher, etc.) higher than a RSRP level/value of the source/serving cell. In this regard, the preparatory handover command manager 82 of the source/serving cell may generate a preparatory handover command indicating that the UE 50 may be handed over to one of these viable candidate cells in the event of a future detection by the UE 50 of a network connection failure, deterioration in radio quality, etc.

The preparatory handover command manager 82 of the source/serving cell (e.g., originating eNB 52) may, but need not, prioritize the candidate cells that the UE 50 may be handed over to by ordering the candidate cells. For example, the preparatory handover command manager 82 of the source/serving cell may prioritize the candidate cells based on their RSRP levels/values. For instance, the preparatory handover command manager 82 of the source/serving cell may assign a candidate cell with a high RSRP level/value to have a higher priority than another candidate cell with a lower RSRP level/value. The priorities of the candidate target cells may be based on aspects other than the radio related parameters. For example, there may be different probabilities regarding the manner in which the UEs are moving between cells. The preparatory handover command manager 82 may also utilize other statistics collected during the normal operation when determining the priorities for the candidate target cells. For example, the preparatory handover command manager 82 may prioritize candidate target cells according to mobility statistics in which a candidate target cell that is determined to have a highest probability of being a target cell is assigned a highest priority.

The preparatory handover command manager 82 of the source/serving cell (e.g., originating eNB 52) may, but need not, arrange/order candidate cells based on their priority in a list that may be included in a message that includes a preparatory handover command generated by the preparatory handover command manager 82 of the source/servicing cell.

Additionally, the preparatory handover command manager 82 of the source/serving cell may send a handover request (also referred to herein as a handover request message) to each of the candidate cells (e.g., target eNB 53) to inform the candidate cells that the UE 50 may be send a preparatory handover command indicating that the UE 50 may handover to one of the candidate cells in the event of a future detection of a network connection failure(s) (e.g., a failed connection with the source/serving cell), deterioration in radio quality, etc. In response to receipt of the handover request, the preparatory handover command manager 82 of each of the candidate cells (e.g., target eNB 53) may send a message such as, for example, a modified handover request acknowledgment message to the source/serving cell acknowledging receipt of the handover message. The message sent from the candidate cells to the source/serving cell acknowledging receipt of the handover request may include one or more parameters including, but not limited to, RadioResourceConfigCommon parameters, RACH-ConfigDedicated parameters or any other suitable parameters, as described above. The preparatory handover command manager 82 of the source/serving cell may utilize these parameters in generating the parameter handover command and may include these parameters in a message with the preparatory handover command.

In response to generating the preparatory handover command with data indicating the candidate cells, the preparatory handover command manager 82 of the source/serving cell may send the preparatory handover command to the UE 50 to enable the preparatory handover command module 80 of the UE 50 to facilitate handover to one of the candidate cells associated with the preparatory handover command in the event of a future detection of a network connection failure, deterioration in radio quality, etc. The detection of a network connection failure, deterioration in radio quality, etc. may be performed by the preparatory handover command module 80 of the UE 50. In this regard, the indication to handover the UE 50 to one of the candidate cells in the event of a future detection of a network connection failure may indicate to the UE 50 that handover may not be immediate or automatic in response to receiving the preparatory handover command, for example, in instances in which there may not be any network connection failures or deteriorations in radio quality detected by the UE 50.

It should be noted that the terms “originating” and “target” are merely used herein to refer to roles that any eNB may play at various different times in relation to being a source/serving (e.g., originating) cell initially providing service to a UE or a neighboring or destination or (e.g., target) cell to which service is to be transferred to, for example, the UE moving from the source cell to the neighboring or destination cell. Thus, the terms “originating” and “target” could be applicable to the same eNB at various different times and such terms are not meant to be limiting in any way.

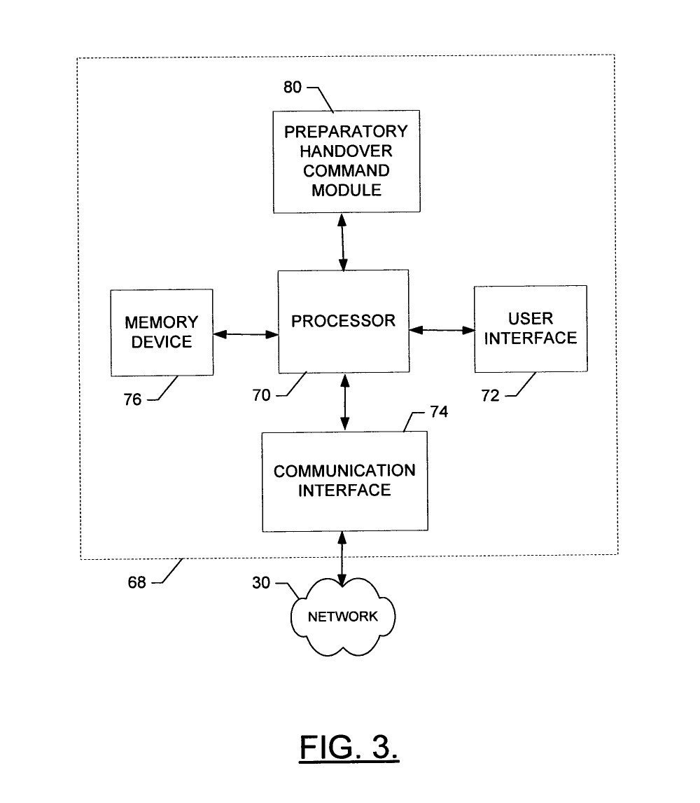

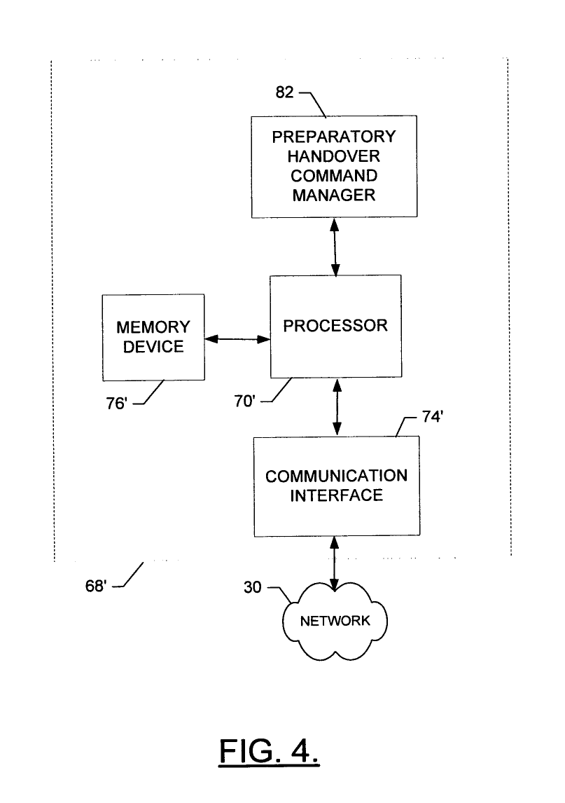

FIGS. 3 and 4 illustrate block diagrams of apparatuses for minimizing a recovery time for connection to a network according to an example embodiment. The apparatus of FIG. 3 may be employed, for example, on the mobile terminal 10. Meanwhile, the apparatus of FIG. 4 may be employed, for example, on the network management system 40, EPC 58 or on the eNBs 52 and 53. However, the apparatuses may alternatively be embodied at a variety of other devices. In some cases, embodiments may be employed on either one or a combination of devices. Furthermore, it should be noted that the devices or elements described below may not be mandatory and thus some may be omitted in certain embodiments.

Referring now to FIG. 3, an apparatus 68 for minimizing a recovery time for connection to a network is provided. The apparatus 68 may include or otherwise be in communication with a processor 70, a user interface 72, a communication interface 74, a memory device 76 and a preparatory handover command module 80. In some embodiments, the processor 70 (and/or co-processors or any other processing circuitry assisting or otherwise associated with the processor 70) may be in communication with the memory device 76 via a bus for passing information among components of the apparatus 68. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 68 may, in some embodiments, be a mobile terminal (e.g., mobile terminal 10 (e.g., UE 50)) or a fixed communication device or computing device configured to employ an example embodiment of the invention. However, in an example embodiment, the apparatus 68 may be embodied as a chip or chip set. In other words, the apparatus 68 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 68 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured, to execute hard coded functionality. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the preparatory handover command module 80. As such, in some embodiments, the processor 70 may be said to cause, direct or control the execution or occurrence of the various functions attributed to the preparatory handover command module 80, as described herein. The preparatory handover command module 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the preparatory handover command module 80, as described herein. Thus, in examples in which software is employed, a device or circuitry (e.g., the processor 70 in one example) executing the software forms the structure associated with such means.

The preparatory handover command module 80 may be configured to generate one or more measurement reports. The measurement reports may include data specifying RSRP levels/values, RSRQ levels/values or any other suitable data of a source/serving cell (e.g., originating eNB 52) as well as one or more neighboring cells (e.g., target eNB 53), as described above. The RSRP levels/values may indicate measured power levels of the source/serving cell and/or one or more of the neighboring cells. Alternatively, the measurement reports may include one or more RSRQ results which may be proportional, for example, to network load and may indicate the conditions when the mobility should be triggered before the radio coverage becomes a problem.

These measurement reports may be provided by the preparatory handover command module 80 to the preparatory handover command manager 82 of the originating eNB 52 (of the source/serving cell). The preparatory handover command manager 82 of the originating eNB 52 may utilize the data of the measurement reports, in part, to generate a preparatory handover command, as described above. Alternatively or additionally, the preparatory handover command manager 82 may utilize inputs other than just the reports (e.g., measurement reports) coming from the preparatory handover command module 80. The other inputs may be, for example, statistics about the mobility between cells which may be collected internally within an eNB, in this example eNB 52. The preparatory handover command module 80 may receive the preparatory handover command in response to the originating eNB 52 generating the preparatory handover command. In one example embodiment, the preparatory handover command manager 82 of the originating eNB 52 may include the preparatory handover command in a message such as, for example, an RRCConnectionReconfiguration message.

In this regard in an instance in which the preparatory handover command module 80 may detect a future network connection failure(s) (e.g., a failed connection with the source/serving cell), a deterioration in radio quality, etc., the preparatory handover module 80 may select a candidate cell (e.g., a highest priority candidate cell) from one or more candidate cells identified in the message associated with the preparatory handover command to facilitate handover of the apparatus 68 (e.g., UE 50) to the selected candidate cell (e.g., target eNB 53).

In an example embodiment, the apparatus 68 may identify one or more network connection failures or deteriorations in radio quality in instances in which the preparatory handover command module 80 may detect: (1) that the apparatus 68 loses a connection with a source/serving cell (e.g., originating target eNB 52) before a configured event (e.g., generation of one or more measurement reports) triggers; (2) that the apparatus 68 is unable to send a measurement report(s) to a network (e.g., EPC 58, originating eNB 52, etc.) due to a lost connection; (3) that an eNB (e.g., originating eNB 52) is unable to receive or decode a measurement report(s) generated by the preparatory handover command module 80; (3) that a handover command is not successfully received by the apparatus 68; or (4) that the apparatus 68 is unable to establish a connection to a target cell (e.g., target eNB 53) as well as any other suitable conditions/instances that may affect a connection with a network such as, for example, deteriorations in radio quality, etc. For example, the preparatory handover command module 80 may detect one or more network connection failures or deteriorations in radio quality in instances in which: (1) a connection may be lost due to poor network coverage in certain areas of the network (e.g., certain areas of a cell); (2) an interference caused by same layer cells (e.g., intra frequency) causing connection problems; and (3) instances in which connection problems may not be restored in a layer 1 (L1) connection within a predetermined time period, resulting in radio link failure (RLF), and any other suitable instances that may affect network connections and/or radio quality conditions.

As indicated above, FIG. 4 illustrates a block diagram of an apparatus 68′ for minimizing a recovery time for connection to a network from the perspective of a network entity according to an example embodiment. The apparatus 68′ may be employed, for example, on the eNBs 52, 53. In an alternative example embodiment, the apparatus 68′ may be employed, for example, on the network management system 40 or EPC 58. The apparatus 68′ may include several components similar to those of the apparatus 68 of FIG. 3. In this regard, for example, the apparatus 68′ may include components such as a processor 70′, a memory device 76′ and a communication interface 74′ as shown in the example of FIG. 4. The processor 70′, the memory device 76′ and the communication interface 74′ may have similar structural characteristics and functional capabilities to the processor 70, memory device 76 and communication interface 74 of FIG. 3 except perhaps as to scale and semantic differences. Accordingly, a detailed description of these components will not be provided.

In an example embodiment, the apparatus 68′ may further include a preparatory handover command manager 82. In some cases, the processor 70′ may be embodied as, include or otherwise control the preparatory handover command manager 82. As such, in some embodiments, the processor 70′ may be said to cause, direct or control the execution or occurrence of the various functions attributed to the preparatory handover command manager 82, as described herein. The preparatory handover command manager 82 may be any means such as a device or circuitry operating in accordance with software or otherwise embodied in hardware or a combination of hardware and software (e.g., processor 70′ operating under software control, the processor 70′ embodied as an ASIC or FPGA specifically configured to perform the operations described herein, or a combination thereof) thereby configuring the device or circuitry to perform the corresponding functions of the preparatory handover command manager 82, as described herein. Thus, in examples in which software is employed, a device or circuitry (e.g., the processor 70′ in one example) executing the software forms the structure associated with such means.

The preparatory handover command manager 82 may be configured to provide instructions to the UE 50 (e.g., to the preparatory handover command module 80) with respect to the handover of the UE 50 to a candidate cell in response to a future detection of a network connection failure(s) and/or deterioration of radio quality. For example, the preparatory handover command manager 82 may be configured to generate a preparatory handover command that may be sent to the UE 50 in a message (e.g., an RRCConnectionReconfiguration message). The preparatory handover command may include, or be associated with, data indicating one or more candidate cells that the UE 50 may handover to in response to a future detection of a network connection failure and/or deterioration in radio quality.

The preparatory handover command manager 82 of a source/serving (e.g., eNB 52) may also send a message (e.g., a handover request message) to each of the candidate cells informing the candidate cells that the UE 50 may handover to one of the candidate cells in the future based on a future detection of a network connection failure(s) and/or deterioration in radio quality. In response to receipt of the handover request message, a preparatory handover command manager 82 of a candidate cell (e.g., eNB 53) may generate a modified handover request acknowledgement message which may be sent to the preparatory handover command manager 82 of the source/serving cell acknowledging receipt of the handover request message. The preparatory handover command manager 82 of a candidate cell (e.g., eNB 53) may include one or parameters in the modified handover request acknowledgement message that may be utilized by the preparatory handover command manager 82 of the source/serving (e.g., eNB 52) to generate the preparatory handover command and which may be included in, or associated with, the generated preparatory handover command.

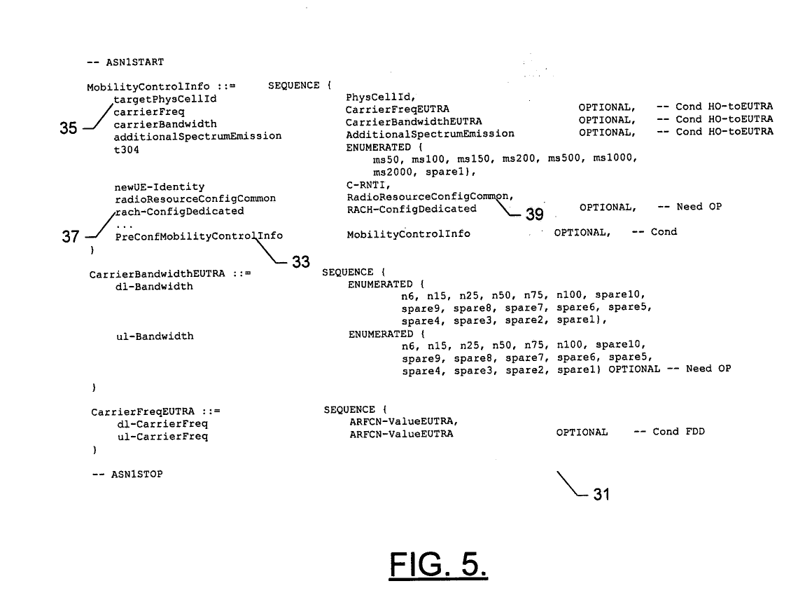

Referring now to FIG. 5, a diagram of an example message including a preparatory handover command according to an example embodiment is provided. In an example embodiment, the message 31 of FIG. 5 may be an RRCConnectionReconfiguration message. However, in an alternative example embodiment the message 31 may be any other suitable message. The message 31 including the handover preparatory command 33 may be generated by the preparatory handover command manager 82 of the originating eNB 52, in the manner described above. The preparatory handover command 33 may be included in information associated with a mobility control information element (e.g., IE). Additionally, the preparatory handover command 33 may denote to the preparatory handover command module 80 of the UE 50 that the UE 50 may be handed over to a candidate cell (e.g., candidate cell 35) identified in the message 31 in response to a future detection of a network connection failure(s) and/or deterioration in radio quality, etc. In the example embodiment of the message 31, the preparatory handover command manager 82 of the originating eNB 52 may include the parameters 37 (e.g., RACH-ConfigDedicated parameters) and parameters 39 (e.g., RadioResourceConfigCommon) received in a modified handover request acknowledgement from a preparatory handover command manager 82 of a candidate cell (e.g., candidate cell 35 (e.g., target eNB 53)).

The generated preparatory handover command may be optimized so that redundant information may be omitted by the preparatory handover command module 82 of a source/serving cell (e.g., originating eNB 52). For instance, some L1 related parameters may not be different in the neighboring cells. For example, if two or more candidate cells are on the same carrier frequency it may be unnecessary to include the carrier frequency twice in a message (e.g., message 31) such as, for example, an RRCConnectionReconfiguration message. As such, the preparatory handover command module 82 of the source/serving cell (e.g., originating eNB 52) may not include these redundant parameters in a message including the preparatory handover command.

Additionally, in an example embodiment, the candidate target cells may not be limited to the same radio access technology (RAT). For instance, in an example embodiment the system of FIG. 2 may, but need not, include scattered E-UTRAN coverage (e.g., non-continuous E-UTRAN coverage) in which source cells (e.g., source/serving cell (e.g., originating eNB 52) and target cells (e.g., target eNB 53)) may be UTRAN or GERAN cells or other any other suitable cells. As such, in an instance in which the UE 50 may move from one a cell supporting one RAT to another cell supporting another RAT, connections with the cell that the UE is being handed over to may be fast since scanning, verifying and selecting E-UTRAN neighbor cells may be unnecessary.

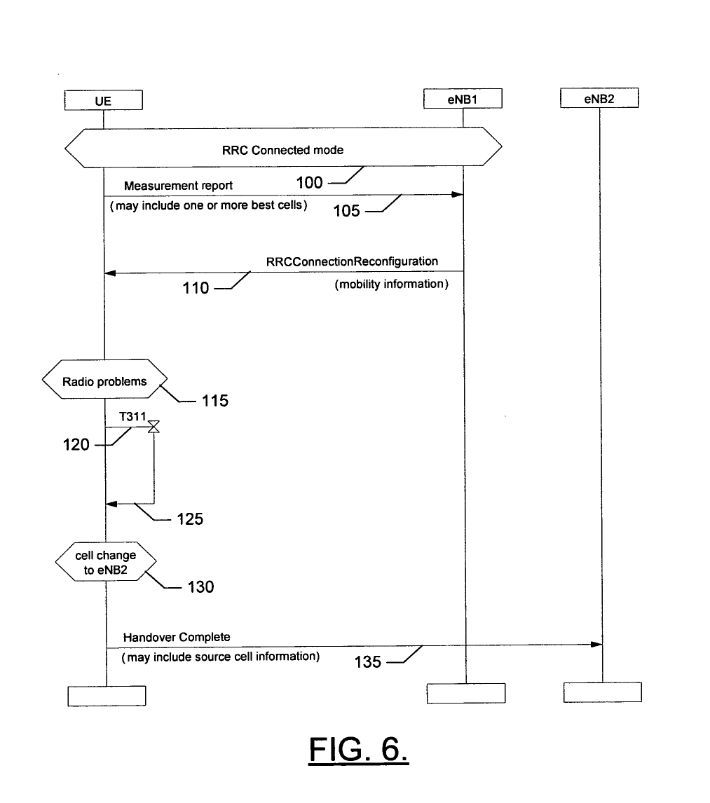

FIG. 6 illustrates a control flow diagram showing an example of signaling that may be exchanged in the performance of one example embodiment. As shown in FIG. 6, the UE (e.g., UE 50) may initially be in communication with a first eNB (e.g., source eNB1 (e.g., eNB 52)). For instance, the UE and the first eNB may be in a Radio Resource Control (RRC) connected mode at operation 100. The UE may be configured by source eNB1 to provide measurement reports to source eNB1. Thus, the UE may generate one or more measurement reports and may send the measurement reports to the eNB1, as indicated at operation 105. The measurement reports may include data indicating one or more best cells. The data in the measurement reports indicating the one or more best cells may be based in part on one or more corresponding RSRP levels/values RSRQ levels/values, and any other suitable data (e.g., measurements). At operation 110, the eNB1, may generate a message (e.g., an RRCConnectionReconfiguration message) that may include a preparatory handover command indicating, or associated with, one or more candidate target cells that the UE may be handed over to in response to a future detection of a network connection failure(s) and/or future detection of deterioration in radio quality. The message including the preparatory handover command may also include mobility information. In an example embodiment, in an instance in which the UE receives the message from the eNB1, the UE may be in a normal mode in an RRC connected mode performing cell detection, measurements, radio link monitoring (RLM) and any other suitable functions. The UE may store the message and may utilize the data associated in part with the preparatory handover command to perform a handover in the future based on detection of a network connection failure(s) and/or deterioration in radio quality.

At operation 115, the UE may detect one or more radio problems. The radio problems may be associated with a detection of a network connection failure(s) (e.g., a lost connection with a source cell (e.g., eNB1)) and/or deterioration in radio conditions/quality, etc. The UE may attempt to reestablish the connection with the network or resolve the deterioration in radio conditions/quality within a predetermined time period (also referred to herein as T311), at operation 120. The UE may determine or detect that a connection failure (e.g., radio link failure) occurred in response to being unable to reestablish the network connection or resolve the deterioration in radio conditions/quality upon expiration of the predetermined time period, at operation 125.

At operation 130, the UE may examine data in the message (e.g., RRCConnectionReconfiguration message) received from the eNB1 including the preparatory handover command and may select a best candidate target cell for handover. In this regard, the UE may select data identifying the eNB2 from the message (e.g., RRCConnectionReconfiguration message) and may change or be handed over to the eNB2. In response to the UE selecting eNB2 from the message, the UE may send a message to the eNB2 indicating that handover to the eNB2 is complete, at operation 135. The message (e.g., a handover complete message) sent from the UE to the eNB2, indicating that handover is complete, may, but need not, include some source cell (e.g., eNB1) information. The indication that handover is complete may indicate the presence of the UE in the target cell of eNB2 (e.g., eNB53).

Although the example above may relate to an application of an example embodiment pertaining to E-UTRAN, other example embodiments could be practiced in similar fashion with respect to UTRAN or even other networks.

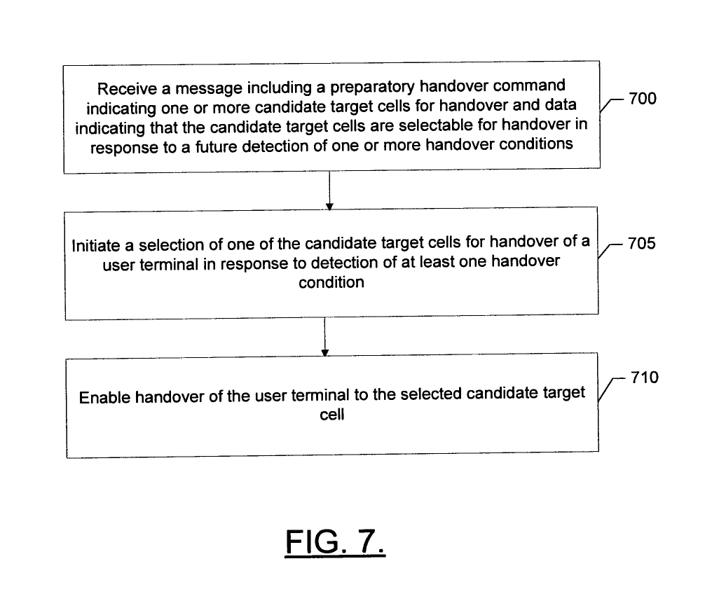

FIG. 7 is a flowchart of a method and program product according to an example embodiment of the invention. At operation 700, a user terminal (e.g., UE 50) may receive a message (e.g., a RRCConnectionReconfiguration message) including a preparatory handover command indicating, or associated with, one or more candidate target cells (e.g., target eNB 53) for handover and data indicating that the candidate target cells are selectable for handover in response to a future detection of one or more handover conditions (e.g., network connection failures). At operation 705, a user terminal (e.g., UE 50) may initiate a selection of one of the candidate target cells for handover of the user terminal in response to detection of at least one handover condition (e.g., network connection failure (e.g., radio link failure)). At operation 710, a user terminal (e.g., UE 50) may enable handover of the user terminal to the selected candidate target cell.

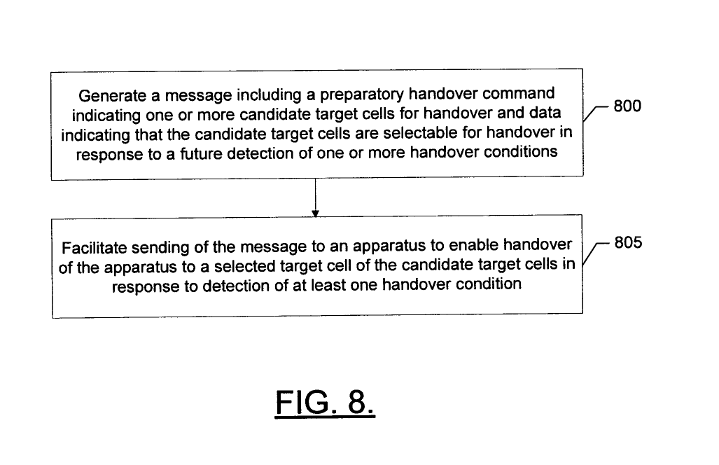

Referring now to FIG. 8, a flowchart of a method and program product for minimizing a recovery time for establishing connection to a network according to an example embodiment of the invention is provided. At operation 800, a first apparatus (e.g., eNB 52), of a source cell, may generate a message (e.g., an RRCConnectionReconfiguration message) including a preparatory handover command indicating, or associated with, one or more candidate target cells for handover and data indicating that the candidate target cells are selectable for handover in response to a future detection of one or more handover conditions (e.g., network connection failures). At operation 805, the first apparatus may facilitate sending of the message to an apparatus (e.g., UE 50) to enable handover of the apparatus to a selected target cell (e.g., target eNB 53) of the candidate target cells in response to detection of at least one handover condition (e.g., network connection failure (e.g., radio link failure)).

It should be pointed out that FIGS. 6, 7 and 8 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 76′) and executed by a processor (e.g., processor 70, processor 70′, preparatory handover command module 80, preparatory handover command manager 82). As will be appreciated, any such computer program instructions may be loaded onto a computer or other programmable apparatus (e.g., hardware) to produce a machine, such that the instructions which execute on the computer or other programmable apparatus cause the functions specified in the blocks of the flowcharts to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the blocks of the flowcharts. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the blocks of the flowcharts.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 6, 7 and 8 above may comprise a processor (e.g., the processor 70, processor 70′, preparatory handover command module 80, preparatory handover command manager 82) configured to perform some or each of the operations (100-135, 700-710 and 800-805) described above. The processor may, for example, be configured to perform the operations (100-135, 700-710 and 800-805) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (100-135, 700-710 and 800-805) may comprise, for example, the processor 70 (e.g., as means for performing any of the operations described above), the processor 70′, the preparatory handover command module 80, the preparatory handover command manager 82 and/or a device or circuit for executing instructions or executing an algorithm for processing information, as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving a message comprising a preparatory handover command indicating one or more candidate target cells for handover and data indicating that the candidate target cells are selectable for handover in response to a future detection of one or more handover conditions;
initiating, via a processor, a selection of one of the candidate target cells for handover of an apparatus in response to detection of at least one of the handover conditions; and
enabling handover of the apparatus to the selected candidate target cell.

2. The method of claim 1, wherein at least one of the handover conditions comprises at least one network connection failure.

3. The method of claim 1, wherein enabling handover comprises enabling handover of the apparatus to the selected candidate target cell in response to an unsuccessful attempt to reestablish a connection to a network within a predetermined time period.

4. The method of claim 1, wherein prior to receiving the message, the method further comprising:
generating one or more measurement reports comprising data indicating respective power levels of each of the candidate target cells to enable generation of the preparatory handover command based in part on the data of the measurement reports.

5. The method of claim 1, wherein prior to receiving the message, the method further comprising:
collecting statistics about a behavior of the handover to enable generation of the preparatory handover command based in part on the data of the measurement reports.

6. The method of claim 5, wherein the statistics correspond to the probabilities of one or more apparatuses moving from a source cell to one or more neighbor cells corresponding to the candidate target cells.

7-10. (canceled)

11. The method of claim 1, wherein the candidate target cells are prioritized according to mobility statistics, wherein a candidate target cell having a highest probability of being the target cell is assigned a highest priority.

12. The method of claim 1, wherein the message comprising the preparatory handover command comprises one or more parameters from the candidate target cells to enable handover of the apparatus to at least one of the candidate target cells.

13. (canceled)

14. The method of claim 2, wherein the at least one network connection failure comprises at least one of a detection of a connection failure with a network device or a deterioration in radio quality or conditions.

15. An apparatus comprising:
at least one processor; and
at least one memory including computer program code configured to, with the at least one processor, cause the apparatus to perform at least the following:
receive a message comprising a preparatory handover command indicating one or more candidate target cells for handover and data indicating that the candidate target cells are selectable for handover in response to a future detection of one or more handover conditions;
initiate a selection of one of the candidate target cells for handover of the apparatus in response to detection of at least one of the handover conditions; and
enable handover of the apparatus to the selected candidate target cell.

16. The apparatus of claim 15, wherein the memory and computer program code are further configured to, with the processor, cause the apparatus to:
enable detection of at least one network connection failure, wherein at least one of the handover conditions comprises the network connection failure.

17. The apparatus of claim 15, wherein the memory and computer program code are further configured to, with the processor, cause the apparatus to:
enable handover by enabling handover of the apparatus to the selected candidate target cell in response to an unsuccessful attempt to reestablish a connection to a network within a predetermined time period.

18. The apparatus of claim 15, wherein prior to receive the message, the memory and computer program code are further configured to, with the processor, cause the apparatus to:
generate one or more measurement reports comprising data indicating respective power levels of each of the candidate target cells to enable generation of the preparatory handover command based in part on the data of the measurement reports.

19. The apparatus of claim 15, wherein prior to receive the message, the memory and computer program code are further configured to, with the processor, cause the apparatus to:
collect statistics about a behavior of the handover to enable generation of the preparatory handover command based in part on the data of the measurement reports.

20. The apparatus of claim 19, wherein the statistics correspond to the probabilities of one or more apparatuses moving from a source cell to one or more neighbor cells corresponding to the candidate target cells.

21-24. (canceled)

25. The apparatus of claim 15, wherein the candidate target cells are prioritized according to mobility statistics, wherein a candidate target cell having a highest probability of being the target cell is assigned a highest priority.

26. The apparatus of claim 15, wherein the message comprising the preparatory handover command comprises one or more parameters from the candidate target cells to enable handover of the apparatus to at least one of the candidate target cells.

27. (canceled)

28. The apparatus of claim 16, wherein the at least one network connection failure comprises at least one of a detection of a connection failure with a network device or a deterioration in radio quality or conditions.

29. A computer program product comprising at least one non-transitory computer-readable storage medium having computer-readable program code portions stored therein, the computer-readable program code portions comprising:
program code instructions configured to facilitate receipt of a message comprising a preparatory handover command indicating one or more candidate target cells for handover and data indicating that the candidate target cells are selectable for handover in response to a future detection of one or more handover conditions;
program code instructions configured to initiate a selection of one of the candidate target cells for handover of an apparatus in response to detection of at least one of the handover conditions; and
program code instructions configured to enable handover of the apparatus to the selected candidate target cell.

30. The computer program product of claim 29, further comprising:
program code instructions configured to enable handover by enabling handover of the apparatus to the selected candidate target cell in response to an unsuccessful attempt to reestablish a connection to a network within a predetermined time period.

31-36. (canceled)
